(19) United States
(12) Patent Application Publication
(10) Pub. No.: US 2026/0254060 A1
(43) Pub. Date: Aug. 27, 2026

(54) SECONDARY BATTERY INCLUDING FOLDED PORTION OF ELECTRODE TAB AND METHOD OF MANUFACTURING SAME

(71) Applicant: Samsung SDI Co., Ltd., Yongin-si (KR)

(72) Inventor: Misun Lee, Yongin-si (KR)

(73) Assignee: Samsung SDI Co., Ltd., Yongin-si (KR)

(21) Appl. No.: 19/456,278

(22) Filed: Jan. 22, 2026

(30) Foreign Application Priority Data
Feb. 26, 2025 (KR) 10-2025-0025349

(51) Int. Cl. H01M 50/536; H01M 50/103; H01M 50/105; H01M 50/533; H01M 50/538; H01M 50/54; H01M 50/586; H01M 50/595

(52) U.S. Cl. CPC H01M 50/536; H01M 50/103; H01M 50/105; H01M 50/533; H01M 50/538; H01M 50/54; H01M 50/586; H01M 50/595

(57) ABSTRACT

The present disclosure relates to a secondary battery including a folded portion of an electrode tab and a method of manufacturing the same. In order to improve a welding process and increase space utilization due to a recent increase in battery capacity, there is provided a secondary battery including an exterior material of a secondary battery, an electrode assembly including a plurality of electrode plates, each of which is accommodated in the exterior material and has an electrode tab formed thereon, and a strip conductor welded to the electrode tab formed on the electrode plate, wherein the electrode tab of the electrode plate of the electrode assembly includes a first welded portion formed by welding the electrode tabs formed on the plurality of electrode plates to one another, a second welded portion formed by welding the strip conductor, and a folded portion.

### CROSS-REFERENCE TO RELATED APPLICATIONS

This present application claims priority to and the benefit under 35 U.S.C. § 119(a)-(d) of Korean Patent Application No. 10-2025-0025349, filed on Feb. 26, 2025, in the Korean Intellectual Property Office, the entire disclosure of which is incorporated herein by reference.

### FIELD

The present disclosure relates to a secondary battery, and more particularly, to a secondary battery including an electrode tab-strip conductor welded portion and a folded portion of an electrode tab, and a method of manufacturing the same.

### BACKGROUND

Unlike primary batteries that cannot be recharged, secondary batteries are batteries that can be recharged. Typically, a secondary battery includes an electrode assembly formed of positive and negative electrode plates and a separator.

The herein information disclosed in this Background section is for enhancement of understanding of the background of the present disclosure, and therefore, it may contain information that does not constitute a related (or prior) art.

### SUMMARY

Recently, with the increase in battery capacity, the number of electrode plates (and thus the number of electrode tabs) has increased, making it difficult to set ultrasonic and/or laser welding conditions, and thus, an improved welding process is required. In addition, there is a need to increase space utilization by accommodating an electrode assembly in an exterior material.

According to aspects of the present disclosure, there is provided a secondary battery including an exterior material of a secondary battery, which includes a plurality of electrode plates, each of which is accommodated in the exterior material and has an electrode tab formed thereon; and a strip conductor welded to the electrode tab formed on the electrode plate; wherein the electrode tab of the electrode plate of the electrode assembly includes a first welded portion formed by welding the electrode tabs formed on the plurality of electrode plates to one another, a second welded portion formed by welding the strip conductor, and a folded portion.

According to aspects of the present disclosure, there is provided a secondary battery including an exterior material of a secondary battery, which includes a plurality of electrode plates, each of which is accommodated in the exterior material and has an electrode tab formed thereon; and a strip conductor welded to the electrode tab formed on the electrode plate; wherein the electrode tab of the electrode plate of the electrode assembly includes a first welded portion formed by welding electrode tabs formed on the plurality of electrode plates to one another, a second welded portion formed by welding the strip conductor, an insulating tape attached to an electrode tab formed on at least one electrode plate located on an outer side among the plurality of electrode plates, and a folded portion in which the electrode tab and insulating tape are folded.

According to still aspects of the present disclosure, there is provided a method of manufacturing a secondary battery, which includes providing an electrode assembly including a plurality of electrode plates on which electrode tabs are formed; forming a first welded portion by welding the electrode tabs formed on the plurality of electrode plates to one another; forming a second welded portion by welding a strip conductor to the welded electrode tabs; folding the electrode tab on which the first welded portion is formed; and accommodating the electrode assembly in an exterior material.

Aspects and features of the present disclosure are not limited to those described herein, and other aspects and features not specifically mentioned herein will be clearly understood by those skilled in the art from the description of the present disclosure herein.

### BRIEF DESCRIPTION OF THE DRAWINGS

The following drawings attached to the present specification illustrate embodiments of the present disclosure and further describe aspects and features of the present disclosure together with the detailed description of the present disclosure. Thus, the present disclosure should not be construed as being limited to the drawings, in which:

FIG. 1 is a schematic diagram illustrating one type of an electrode assembly of a secondary battery;

FIGS. 2A and 2B are a schematic diagram illustrating another type of an electrode assembly of a secondary battery;

FIG. 3 is a schematic diagram illustrating a pouch-type secondary battery to which the electrode assembly manufactured according to the present disclosure is applicable;

FIG. 4 is a schematic diagram illustrating a prismatic secondary battery to which the electrode assembly manufactured according to the present disclosure is applicable;

FIG. 5 is a cross-sectional schematic diagram illustrating the electrode assembly shown in FIGS. 3 and 4;

FIG. 6 is a front view for further describing a folded portion of an electrode tab formed on an electrode plate;

FIG. 7 is a front view for describing a folded portion of an electrode tab according to embodiments;

FIG. 8A is a process flowchart illustrating a method of manufacturing a secondary battery according to some embodiments of the present disclosure;

FIG. 8B is a diagram for specifically describing a manufacturing process of the electrode assembly;

FIG. 8C is a front view of the electrode plate for describing electrode tab welding and electrode tab-strip conductor welding;

FIG. 9A is a process flowchart illustrating a method of manufacturing a secondary battery according to some other embodiments of the present disclosure;

FIG. 9B is a cross-sectional schematic diagram illustrating an electrode assembly according to embodiments different from the embodiments of FIG. 5;

FIG. 10 is an exemplary diagram illustrating a secondary battery pack; and

FIG. 11 is an exemplary diagram illustrating a vehicle equipped with the secondary battery pack.

### DETAILED DESCRIPTION

Hereinafter, embodiments of the present disclosure will be described in detail with reference to the accompanying drawings.

The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her disclosure in the best way.

The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

In the figures, dimensions of the various elements, layers, etc. may be exaggerated for clarity of illustration. In addition, the same reference numerals may be assigned to the same components in different embodiments.

References to two compared elements, features, etc. as being “the same” may mean that they are “substantially the same.” Thus, the phrase “substantially the same” may include a case having a deviation that is considered low in the art, for example, a deviation of 5% or less. In addition, uniformity of a parameter in a predetermined region may imply uniformity from an average perspective.

Although the terms first, second, and the like are used to describe various components, these components are substantially not limited by these terms. These terms are only used for distinguishing one component from another component, and unless otherwise stated, it is of course that a first component may also be a second component.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to one another, or another component may be “interposed” between the components.”

As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list.

Throughout the specification, if “A and/or B” is stated, it means A, B or A and B, unless otherwise stated and if “C to D” is stated, it means C or more and D or less, unless otherwise stated.

When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C.

As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed herein could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below.

The terminology used herein is for the purpose of describing embodiments of the present disclosure and is not intended to limit the present disclosure.

Positive or negative electrode plates may be manufactured through a coating process of coating one or both surfaces of a substrate with an active material mixture, a roll pressing process of pressing and stretching the electrode plates coated with the mixture through the coating process to form thin, flat electrode plates, a slitting process of cutting the coated electrode plates in multiple rows in a longitudinal direction to separate the cut electrode plates into individual electrode plates, and a notching process of cutting the separated individual electrode plate in a transverse direction, removing unnecessary portions, and forming tabs.

The electrode plate may include an uncoated portion that is not coated with an electrode material. This uncoated portion is not coated with an electrode material and a metal substrate is exposed. A strip conductor is welded to an electrode tab (referred to as a substrate tab) formed on the uncoated portion. The strip conductor may serve as an electrical connection between the electrode plate and an external terminal, and in other examples, the strip conductor itself may be exposed to the outside and may serve as a terminal.

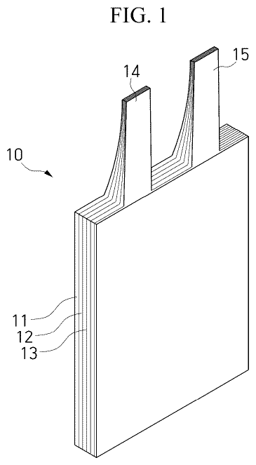

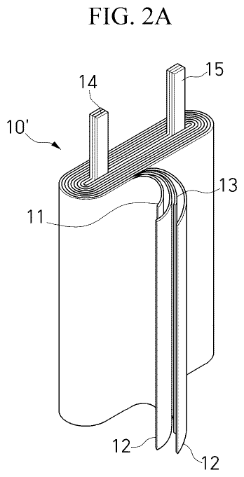

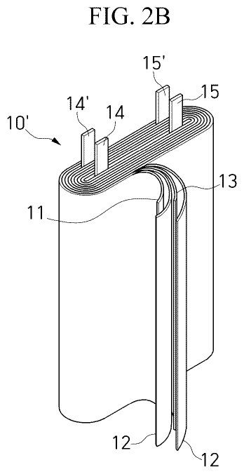

FIGS. 1, 2A, and 2B schematically illustrate an example of an electrode assembly of a secondary battery.

Electrode assemblies 10, 10′ may be manufactured by stacking individual sheets of a first electrode plate 11, a separator 12, and a second electrode plate 13 as shown in FIG. 1 or by winding each continuum of the first electrode plate 11, the separator 12, and the second electrode plate 13 as shown in FIGS. 2A and 2B. However, in a different form from the electrode assembly 10 shown in FIGS. 1, 2A, and 2B, there is also a Z-stack type electrode assembly (not shown) in which a first electrode plate and a second electrode plate are inserted into both sides of a separator bent in a Z shape.

If the first electrode plate 11 is a negative electrode, the first electrode plate 11 is formed by coating a metal substrate such as copper, a copper alloy, nickel, or a nickel alloy with an active material such as graphite or carbon and may include a first electrode tab 14, which is an area in which the active material is not applied. If the second electrode plate 13 is a positive electrode, the second electrode plate 13 is formed by coating a metal substrate such as aluminum or an aluminum alloy with an active material such as a lithium transition metal oxide and may include a second electrode tab 15, which is an area in which the active material is not applied.

As shown in FIGS. 1 and 2A, a structure in which a plurality of electrode tabs 14, 15 are formed is referred to a multi-tab structure. In the multi-tab structure, the first electrode tabs 14 are welded to one another and the second electrode tabs 15 are welded to one another, and a strip conductor is welded to the welded electrode tabs 14, 15, and the strip conductor may be electrically connected to an external terminal. FIG. 2B shows an electrode assembly 10′ having a 2-positive 2-negative (2P2N) structure in which a pair of first electrode tabs 14, 14′ and a pair of second electrode tabs 15, 15′ are formed. Even in this type, the first electrode tabs 14, 14′ are welded to one another and the second electrode tabs 15, 15′ are also welded to one another.

The separator 12 functions to prevent a short circuit between the first electrode plate 11 and the second electrode plate 13 while allowing the movement of lithium ions. The separator 12 may be made of, for example, a polyethylene film, a polypropylene film, a polyethylene-polypropylene film, etc.

In some embodiments, the electrode assemblies 10, 10′ may be accommodated in an exterior material such as a pouch, a case, a can, etc., and filled with an electrolyte. In the case of a pouch-type secondary battery, the electrode assembly may be accommodated in a pouch made of a flexible material, and in the case of a cylindrical or prismatic secondary battery, the electrode assembly may be accommodated in a cylindrical or hexahedral metal case or can.

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the herein formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x≤2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99.5 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on one another.

Recently, with the increase in battery capacity, the number of electrode plates (and thus the number of electrode tabs) has increased, making it difficult to set ultrasonic and/or laser welding conditions, and thus, process improvements are required. In particular, issues related to quality degradation (weak welds, non-welds, missing welds, etc.) are occurring when welding between an increased number of electrode tabs. In addition, there is a need to increase the space utilization required when an electrode assembly is accommodated in an exterior material.

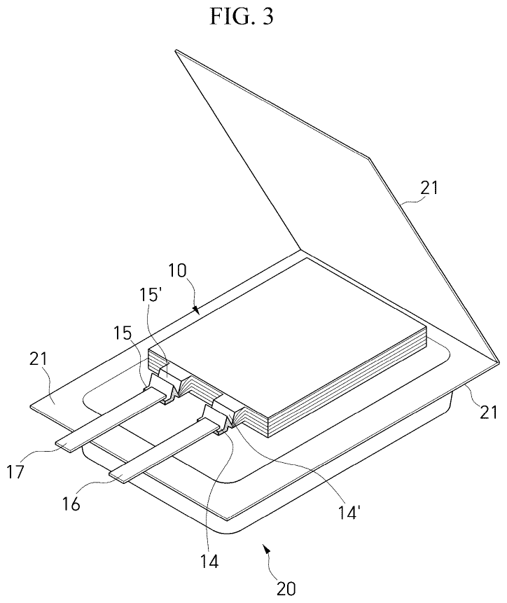

FIG. 3 is a schematic diagram illustrating a pouch-type secondary battery according to some embodiments of the present disclosure.

The pouch-type secondary battery according to the embodiments may include an electrode assembly 10 and a pouch 20 for accommodating the electrode assembly 10. In FIG. 3, the illustrated electrode assembly 10 is the stack-type electrode assembly of FIG. 1, but the winding-type electrode assembly 10′ of FIG. 2 may also be applied.

The first electrode tab 14 and the second electrode tab 15 of the electrode assembly 10 may be respectively welded to a first strip conductor 16 and a second strip conductor 17, which function as terminals exposed to the outside. An insulating film (not shown) for insulation from the pouch 20 and for sealing the interior of the pouch 20 may be attached to the first strip conductor 16 and the second strip conductor 17.

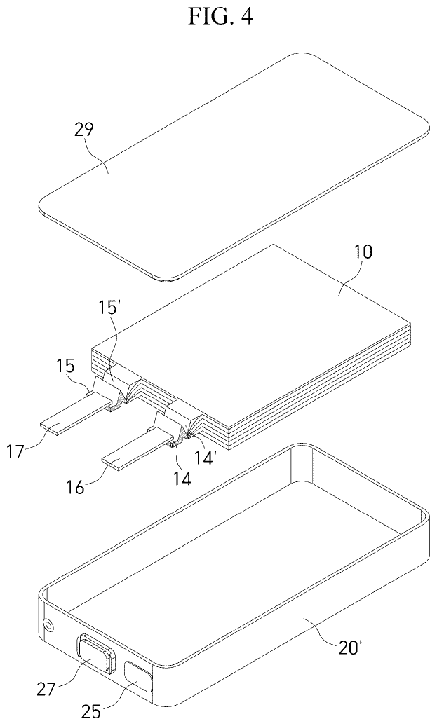

FIG. 4 is a schematic diagram illustrating a prismatic secondary battery according to embodiments of the present disclosure.

The illustrated prismatic secondary battery has a structure in which a wide lateral surface of a can 20′, which is an exterior material of the battery, is open, the electrode assembly 10 is inserted into the opening, and a cover 29 covers the opening. The first strip conductor 16 and the second strip conductor 17 may be connected to the first electrode tab 14 and the second electrode tab 15 of the electrode assembly 10 inside the external can 20′ by welding. The first strip conductor 16 and the second strip conductor 17 are respectively electrically connected to the first terminal 25 and the second terminal 27, which are exposed to the outside of the can 20′.

In FIGS. 3 and 4, the electrode assembly 10 has a multi-tab structure having a plurality of electrode tabs 14, 15 as described in FIGS. 1 and 2. The plurality of electrode tabs 14, 15 are welded and folded to constitute folded portions 14′, 15′, respectively. A distance between ends of the strip conductors 16, 17 and the electrode assembly 10 may be reduced by the folded portions 14′, 15′. The welding of the plurality of electrode tabs 14, 15 may be performed using ultrasonic welding or laser welding. Similarly, the welding of the plurality of welded electrode tabs 14, 15 and the strip conductors 16, 17 may also be performed using ultrasonic welding or laser welding.

In some embodiments, the first and second strip conductors 16, 17 are welded to the first and second electrode tabs 14, 15, respectively, and are themselves exposed to the outside of the pouch 20 as shown in FIG. 3 to serve as terminals. In embodiments, the first and second strip conductors 16, 17 are respectively welded to the first and second electrode tabs 14, 15 to serve to mediate an electrical connection between the terminals 25, 27, which are exposed to the outside of the battery can (or case) 20, and the electrode tab 14 as shown in FIG. 4.

Hereinafter, for convenience of description and understanding, the first and second strip conductors 16, 17 will be collectively referred to as a “strip conductor 16,” and the first and second electrode tabs 14, 15 will be collectively referred to as an “electrode tab 14.”

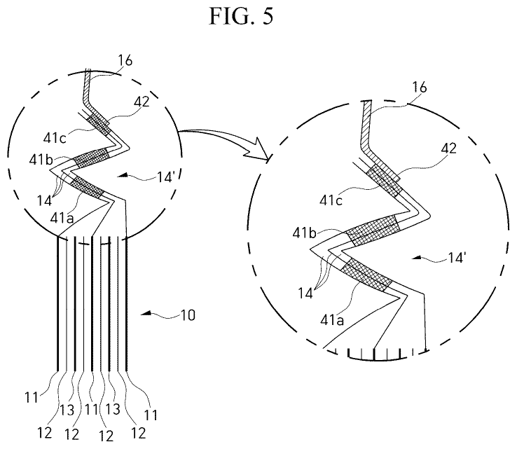

FIG. 5 is a cross-sectional schematic diagram illustrating the electrode assembly shown in FIGS. 3 and 4.

The electrode assembly 10 shown in FIG. 5, as shown in FIGS. 3 and 4, may be accommodated in the secondary battery exterior materials 20 and 20′. The exterior material may be the exterior pouch 20 of FIG. 3 in the case of a pouch-type secondary battery and may be an external can 20′ in the case of a prismatic secondary battery.

As described herein, the electrode assembly 10 is manufactured by stacking or winding the plurality of electrode plates 11, 13 and the separator 12, and the electrode tabs 14, 15 formed in the uncoated portions not coated with materials are formed in the electrode plates 11, 13.

In FIG. 5, only one electrode tab 14 among the electrode tabs 14, 15 shown in FIGS. 3 and 4 is shown. Accordingly, only one folded portion 14′ of the folded portions 14′, 15′ of the electrode tabs 14, 15 is shown. That is, although only the first electrode tab 14 formed on the first electrode plate 11, the first strip conductor 16 welded the first electrode tab 14, and the folded portion 14′ of the first electrode tab 14 are shown in FIG. 5, the same structure is applied even in the case of the second electrode tab 15 (not shown) formed on the second electrode plate 13, the second strip conductor 17 (not shown) welded to the second electrode tab 15, and the folded portion 15′ of the second electrode tab 15.

The electrode tabs formed on the plurality of electrode plates 11 are welded to one another to form the first welded portions 41a, 41b, 41c. In FIG. 5, the first welded portions 41a, 41b, 41c are formed at three positions, but the present disclosure is not limited thereto. The strip conductor 16 is welded to the ends of the electrode tabs 14, which are welded to one another, to form a second welded portion 42.

The first welded portions 41a, 41b, 41c of the electrode tabs 14 may be formed by ultrasonic welding, but the present disclosure is not limited thereto. The second welded portion 42 may be formed by laser welding, but the present disclosure is not limited thereto.

The electrode tabs 14, on which the first welded portions 41a, 41b, 41c and the second welded portion 42 are formed, has a folded portion 14′ folded parallel to the side surface of the electrode assembly 10. In the embodiments of FIG. 5, the folded portion 14′ is shown to be folded three times, but the present disclosure is not limited thereto.

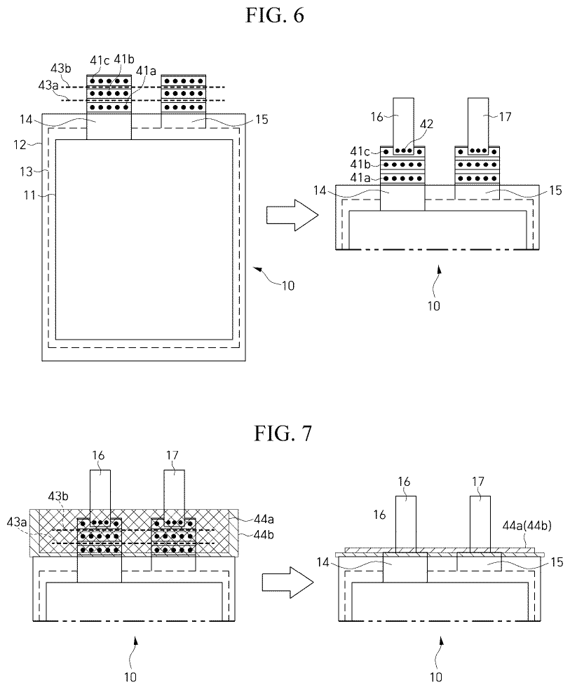

FIG. 6 is a front view for further describing the folded portion 14′ (see FIG. 5) of the electrode tabs 14 formed on the electrode plates 11. A folded portion of the electrode tab 15 formed on another electrode plate 13 is shown in FIG. 6.

As seen in the left drawing of FIG. 6, the folded portion 14′ may be folded three times with two folding lines 43a, 43b as boundaries. In this case, the first welded portions 41a, 41b, 41c may be formed in each area defined by the folding lines 43a, 43b. However, the present disclosure is not limited thereto.

The right drawing of FIG. 6 shows the second welded portion 42 formed by welding the strip conductor 16 to an end portion of the electrode tab 14 after the plurality of electrode tabs 14 are welded.

As described herein, all of the electrode tabs of the substrate are welded first using ultrasonic welding so that strength of the electrode tabs increases and thus the strip conductor may be stably laser-welded while preventing the substrate from sagging. When laser welding is performed on the electrode tabs of the plurality of substrates, over-welding, non-welding, pinholes, and the like may occur. However, strip conductors are laser-welded to the electrode tabs first welded using ultrasonic welding so that problems arising from uneven surfaces of the electrode tabs can be resolved. In addition, even when only a portion of the electrode tabs are melted during laser welding and incomplete welding is performed, there is no problem of current conduction in the electrode tabs in which the welded portions are formed in a plurality of areas. In addition, since the first welded portions 41a, 41b, 41c are formed in each area divided by the folding lines 43a, 43b, the possibility of gaps between the electrode tabs 14 when folding the electrode tabs 14 is eliminated, thereby preventing a decrease in electrical conductivity and increasing the utilization of the space within the exterior material of the battery. On the whole, this reduces many of the management tolerances for the welded portions, thereby reducing process defect rates and further contributing to thinner secondary batteries.

FIG. 7 is a front view for describing a folded portion of an electrode tab according to embodiments.

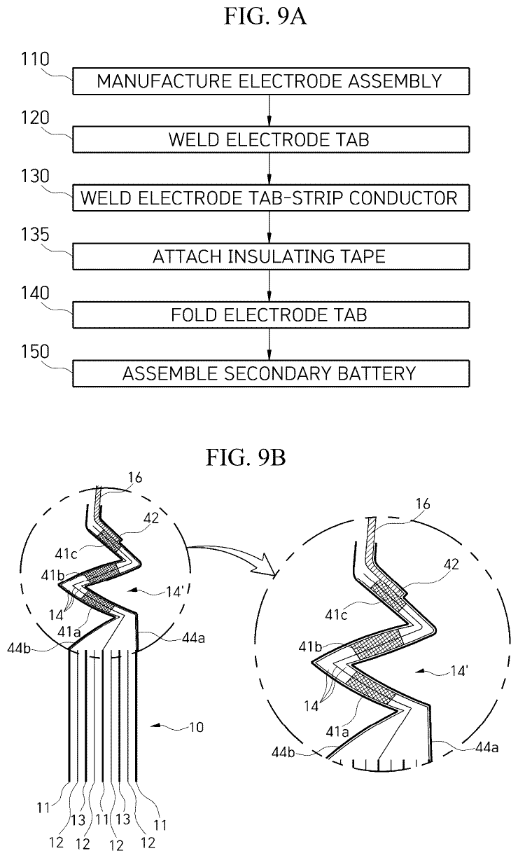

As shown in the left drawing of FIG. 7, the first welded portions 41a, 41b, 41c are welded to each area divided by the folding lines 43a, 43b of the electrode tab 14, the strip conductor 16 is welded to the electrode tab 14 to form a second welded portion 42 and then insulating tapes 44a, 44b are attached. Thereafter, as shown in the right drawing, the electrode tab 14 is folded together with the insulating tapes 44a, 44b. A side cross-sectional view of the electrode tab 14 folded together with the insulating tapes 44a, 44b is shown in FIG. 9B.

In FIG. 7 (also in FIG. 9B), the insulating tapes 44a, 44b may be attached to at least one of two electrode tabs 14 formed on two electrode plates located on an outer side among the plurality of electrode plates constituting the electrode assembly 10. However, FIG. 7 shows an example in which the insulating tapes 44a, 44b are attached to both electrode tabs 14 located on the outer side.

In the embodiments, the insulating tapes 44a, 44b attached to the electrode tab 14 may prevent the electrode tab 14 from being short-circuited with an electrode plate of a different polarity due to the folded portion 14′ generated by folding the electrode tab 14. Insulation between the electrode plates is possible by the separator 12, but for more reliable insulation, the insulating tapes 44a, 44b are additionally used.

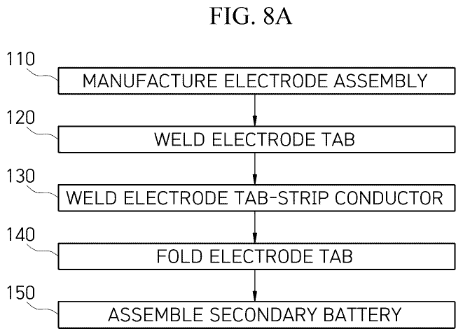

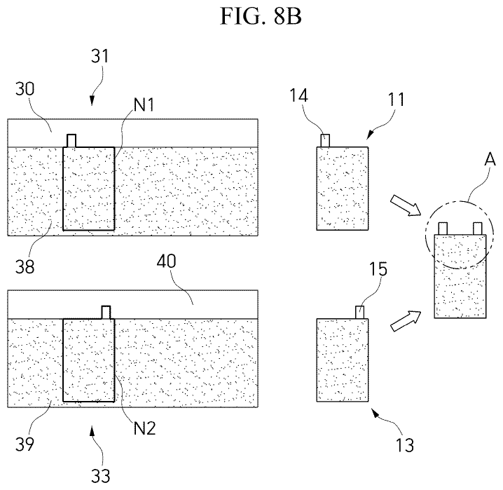

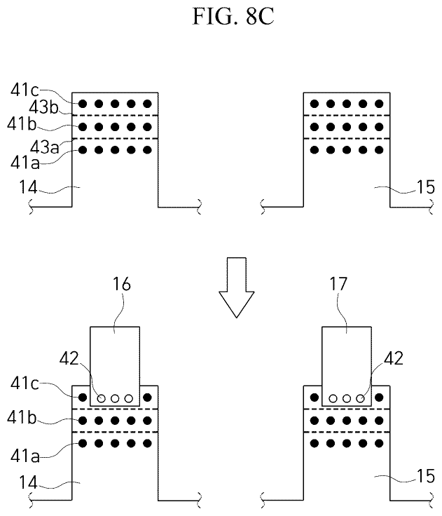

FIGS. 8A to 8C are diagrams for describing a method of manufacturing a secondary battery according to some embodiments of the present disclosure. From the description of the manufacturing method herein, a configuration of the secondary battery according to the present disclosure will be easily understood.

First, FIG. 8A is a process flowchart illustrating a method of manufacturing a secondary battery according to some embodiments of the present disclosure.

110: The electrode plates 11, 13 are manufactured, and then the electrode assembly 10 is manufactured.

A detailed description will be made with reference to FIG. 8B. The first electrode plate 11 is manufactured by notching a coated portion 38 in which an electrode material is applied to a substrate 31 for a first electrode plate and an uncoated portion 30 in which an electrode material is not applied along an outline of N1. The electrode tab 14 may be formed in the uncoated portion 30 by the notching in the N1 shape. Similarly, the second electrode plate 13 is manufactured by notching a coated portion 39 in which an electrode material is applied to a substrate 33 for a second electrode plate and an uncoated portion 40 in which an electrode material is not applied along an outline of N2. The electrode tab 15 may be formed in the uncoated portion 40 of the substrate 33 by the notching in the N2 shape.

The electrode assembly 10 shown in FIG. 1 may be manufactured by stacking the manufactured first electrode plate 11, second electrode plate 13, and a separator (not shown). (The winding-type electrode assembly 10′ shown in FIG. 2 may be manufactured by a process different from the process shown in FIG. 8B.)

120: The electrode tabs 14, 15 formed on the electrode plates 11, 13 included in the manufactured electrode assembly 10 are welded to one another.

In this way, as described herein with reference to FIGS. 5 and 6 and as shown in FIG. 8C, the first welded portions 41a, 41b, 41c are formed. In this case, the first welded portions 41a, 41b, 41c may be formed by avoiding a plurality of folding lines for forming the folded portion by folding the electrode tab 14. For example, as shown in FIG. 6, when the electrode tab 14 is folded three times with two folding lines 43a, 43b as boundaries, the first welded portions 41a, 41b, 41c may be formed in each area divided by the two folding lines 43a, 43b. The welding may be ultrasonic welding, but the present disclosure is not limited thereto. For example, laser welding and resistance welding may also be used.

130: The strip conductors 16, 17 are welded to the welded electrode tabs 14, 15 to form the second welded portion 42 (see FIG. 5, the right side of FIG. 6, and the lower side of FIG. 8C).

As shown in FIGS. 5, 6 and 8C, when the folding lines 43a, 43b are located in the second welded portion 42 during the welding of the strip conductors 16, 17, the second welded portion 42 may be formed by avoiding a corresponding folding line. This is for easy folding of the electrode tab 14.

Laser welding may be used to weld the strip conductors 16, 17, but the present disclosure is not limited thereto. For example, ultrasonic welding, resistance welding, etc. may also be used.

140: The electrode tabs 14, 15 are folded to form the folded portions 14′, 15′.

The folding of the electrode tabs 14, 15 may be performed several times along a plurality of folding lines as boundaries. In the embodiments of FIG. 5, the folding is performed three times, and the folded portions 14′, 15′ formed by folding are formed to be parallel to an edge of the electrode assembly 10.

In FIG. 8A, operation 140 is described as being performed after operation 130, but these two operations may be reversed. That is, unlike the process sequence of FIG. 8A, after the electrode tabs 14, 15 are welded in operation 120, the welded electrode tabs 14, 15 may be folded, and then the strip conductors 16, 17 may be welded.

150: A secondary battery is assembled by accommodating the electrode assembly 10 manufactured by the herein-described process in an exterior material of a battery, and performing processes such as terminal connection, electrolyte injection, degassing, and activation.

FIGS. 9A and 9B are diagrams for describing a method of manufacturing a secondary battery according to some other embodiments of the present disclosure. FIG. 9A is similar to the process flowchart of FIG. 8A and thus will be briefly described.

110: The electrode plates 11, 13 are manufactured and the electrode assembly 10 is manufactured.

This is the same as the description with reference to FIG. 8B.

120: The electrode tabs 14, 15 formed on the electrode plates 11, 13 included in the manufactured electrode assembly 10 are welded to one another.

In this way, as described herein with reference to FIGS. 5 and 7 and as shown in FIG. 8C, the first welded portions 41a, 41b, 41c are formed. In this case, the first welded portions 41a, 41b, 41c may be formed by avoiding a plurality of folding lines for forming the folded portion by folding the electrode tab 14.

130: The strip conductors 16, 17 are welded to the welded electrode tabs 14, 15 to form the second welded portion 42 (see FIG. 5, the right side of FIG. 6, and the left side of FIG. 7).

135: The strip conductor 16 is welded to the electrode tab 14 on which the first welded portions 41a, 41b, 41c are formed to form the second welded portion 42 and then the insulating tapes 44a, 44b are attached. Referring to FIGS. 7 and 9B, the insulating tapes 44a, 44b may be attached to at least one of two electrode tabs 14 formed on two electrode plates located on an outer side among the plurality of electrode plates constituting the electrode assembly 10. However, FIGS. 7 and 9B shows an example in which the insulating tapes 44a, 44b are attached to both electrode tabs 14 located on the outer side. As described herein, the insulating tapes 44a, 44b can prevent the electrode tab 14 from being short-circuited with an electrode plates of a different polarity by folding the electrode tab 14.

140: The electrode tabs 14, 15 are folded to form the folded portions 14′, 15′.

As shown in FIG. 5, the folding of the electrode tabs 14, 15 may be performed several times along a plurality of folding lines as boundaries.

150: A secondary battery is assembled by accommodating the electrode assembly 10 manufactured by the herein-described process in an exterior material of a battery, and performing processes such as terminal connection, electrolyte injection, degassing, and activation.

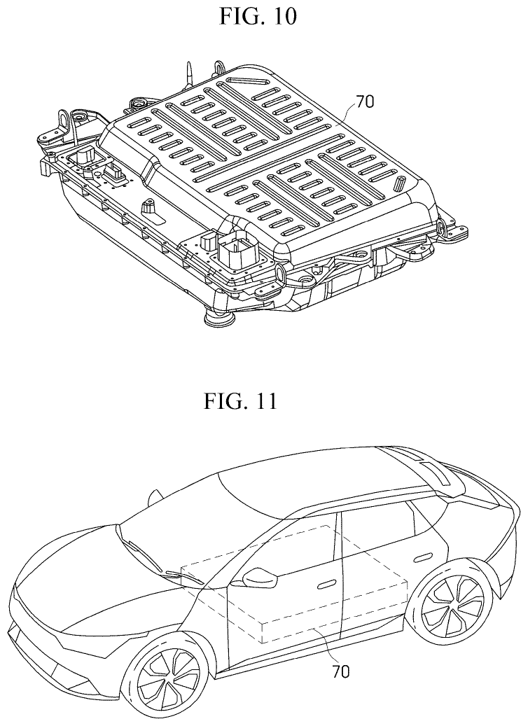

A secondary battery module may be manufactured by arranging and connecting secondary batteries according to the present disclosure in a transverse direction and/or a longitudinal direction. The arrangement of secondary batteries may be designed in terms of arrangement direction and number to obtain the desired voltage and current specifications. A secondary battery pack 70 configured to apply the secondary battery module to an actual product (e.g., an automobile) is shown in FIG. 10. The secondary battery pack may be manufactured by embedding a plurality of secondary battery modules into a pack housing designed to be mounted in an actual product. The pack housing may include related elements such as busbars for electrical connection of the secondary batteries, a cooling unit, and external terminals in addition to fasteners and electrical outlets necessary for mounting in the product. As shown in FIG. 11, the secondary battery pack may be mounted in an automobile. The automobile may be, for example, an electric vehicle, a hybrid vehicle, or a plug-in hybrid vehicle.

According to the present disclosure, all of the electrode tabs of the substrate are welded first using ultrasonic welding so that strength of the electrode tabs increases and thus the strip conductor can be stably laser-welded while preventing the substrate from sagging. When laser welding is performed on a plurality of substrate electrode tabs, over-welding, non-welding, pinholes, and the like can occur. However, strip conductors are laser-welded to the electrode tabs first welded using ultrasonic welding so that problems arising from uneven surfaces of the electrode tabs can be resolved. In addition, even when only a portion of the electrode tabs are melted during laser welding and incomplete welding is performed, there is no problem of current conduction in the electrode tabs in which the welded portions are formed in a plurality of areas. In addition, when the electrode tabs are folded, the possibility of gaps between the electrode tabs is eliminated so that a decrease in electrical conductivity can be prevented and the usability of a space within an exterior material of a battery can be increased.

Although the present disclosure has been described herein with respect to embodiments thereof, the present disclosure is not limited thereto. Various modifications and variations can be made thereto by those skilled in the art within the spirit of the present disclosure as defined by the appended claims and their equivalents.

What is claimed is:

1. A secondary battery comprising:
an exterior material of a secondary battery;
an electrode assembly comprising a plurality of electrode plates, each of which is accommodated in the exterior material and has an electrode tab formed thereon; and
a strip conductor welded to the electrode tab formed on the electrode plate,
wherein the electrode tab of the electrode plate of the electrode assembly comprises a first welded portion formed by welding the electrode tabs formed on the plurality of electrode plates to one another, a second welded portion formed by welding the strip conductor, and a folded portion.

2. The secondary battery as claimed in claim 1, wherein the first welded portion of the electrode tab is formed by ultrasonic welding.

3. The secondary battery as claimed in claim 1, wherein the second welded portion of the electrode tab is formed by laser welding.

4. The secondary battery as claimed in claim 1, wherein:
the folded portion of the electrode tab is folded along a plurality of folding lines; and
the first welded portion is formed in each area divided by the plurality of folding lines.

5. The secondary battery as claimed in claim 1, wherein the electrode assembly further includes an insulating tape attached to an electrode tab formed on at least one electrode plate located on an outer side among the plurality of electrode plates.

6. The secondary battery as claimed in claim 5, wherein the insulating tape is folded together with the folded portion.

7. The secondary battery as claimed in claim 1, wherein the exterior material forms an exterior pouch of a pouch-type secondary battery.

8. The secondary battery as claimed in claim 1, wherein the exterior material forms an external can of a prismatic secondary battery.

9. A secondary battery comprising:
an exterior material of a secondary battery;
an electrode assembly comprising a plurality of electrode plates, each of which is accommodated in the exterior material and has an electrode tab formed thereon; and
a strip conductor welded to the electrode tab formed on the electrode plate,
wherein the electrode tab of the electrode plate of the electrode assembly comprises:
a first welded portion formed by welding electrode tabs formed on the plurality of electrode plates to one another;
a second welded portion formed by welding the strip conductor;
an insulating tape attached to an electrode tab formed on at least one electrode plate located on an outer side among the plurality of electrode plates; and
a folded portion in which the electrode tab and insulating tape are folded.

10. The secondary battery as claimed in claim 9, wherein the first welded portion of the electrode tab is formed by ultrasonic welding.

11. The secondary battery as claimed in claim 9, wherein the second welded portion of the electrode tab is formed by laser welding.

12. The secondary battery as claimed in claim 9, wherein:
the folded portion of the electrode tab is folded along a plurality of folding lines; and
the first welded portion is formed in each area divided by the plurality of folding lines.

13. The secondary battery as claimed in claim 9, wherein the exterior material forms an exterior pouch of a pouch-type secondary battery.

14. The secondary battery as claimed in claim 9, wherein the exterior material forms an external can of a prismatic secondary battery.

15. A method of manufacturing a secondary battery, comprising:
providing an electrode assembly comprising a plurality of electrode plates on which electrode tabs are formed;
forming a first welded portion by welding the electrode tabs formed on the plurality of electrode plates to one another;
forming a second welded portion by welding a strip conductor to the welded electrode tabs;
folding the electrode tab on which the first welded portion is formed; and
accommodating the electrode assembly in an exterior material.

16. The method as claimed in claim 15, wherein the forming of the first welded portion comprises forming the first welded portion by ultrasonic welding.

17. The method as claimed in claim 15, wherein the forming of the second welded portion comprises forming the second welded portion by laser welding.

18. The method as claimed in claim 15, wherein:
the folding of the electrode tab comprises folding the electrode tab along a plurality of folding lines; and
the forming of the first welded portion comprises forming the first welded portion in each area divided by the plurality of folding lines.

19. The method as claimed in claim 15, further comprising attaching an insulating tape to an electrode tab formed on at least one electrode plate located on an outer side among the plurality of electrode plates.

20. The method as claimed in claim 19, wherein the folding of the electrode tab comprises folding the electrode tab and the insulating tape together.
